(19) United States
(12) Patent Application Publication
(10) Pub. No.: US 2020/0211068 A1
(43) Pub. Date: Jul. 2, 2020

(54) PREDICTIVE FRAMEWORK FOR ADMISSION PASS VALUATION

(71) Applicant: General Electric Company, Schenectady, NY (US)

(72) Inventors: Fei HUANG, San Ramon, CA (US); Ramprasad NARASIMHAN, San Ramon, CA (US)

(21) Appl. No.: 16/232,219

(22) Filed: Dec. 26, 2018

(51) Int. Cl. G06Q 30/02; G06Q 10/02; G06N 3/02; G06N 5/00; G06N 20/00

(52) U.S. Cl. CPC G06Q 30/0283; G06Q 30/0206; G06N 20/00; G06N 3/02; G06N 5/003; G06Q 10/02

(57) ABSTRACT

The example embodiments are directed to a predictive framework configured to selectively implement a multi-layered predictive function for admission pass valuation. In one example, the method may include receiving an identification of an admission pass including event attributes and seat location attributes, executing a first predictive algorithm on the event attributes to generate a first predicted value for the admission pass based on values of historical admission passes, executing a second predictive algorithm on the seat location attributes to generate a second predicted value for the admission pass based on the historical values of the historical admission passes, refining the first predicted value based on the second predicted value to generate a multi-layered predicted value for the admission pass, and outputting a display of the multi-layered predicted value to a display.

### BACKGROUND

Selling or reselling admissions passes (e.g., tickets, etc.) to an event is a common occurrence that has recently grown in popularity due to the breadth of Internet connectivity. Online forums provide a mechanism by which sellers can post tickets for sale or resale and buyers can purchase the tickets, often for a different price (i.e., greater or less) than face value. In professional sports such as basketball, football, baseball, hockey, etc., season ticket holders can purchase a group of one or more tickets to every game that will be played during a season. As another example, for events such as plays, theatre, concerts, and the like, admission passes can be purchased for individual events, a years worth of events, and the like.

When a buyer decides they are not going to attend an event, they have the option to resell their admission passes in an effort to recover some or all of the money. For professional sports, a season ticket holder often has the option to sell the tickets back to the team, or sell the tickets via an online forum. Teams often recover thousands of admission passes for resale on a game-by-game basis, and attempt to resell the admission passes for a game in an open forum. In addition, the season ticket holders often try to sell their admission passes in online forums. However, if the admission passes are priced to low, scalpers will purchase the passes, up the value, and resell the admission passes. In contrast, if the admission passes are priced to high, the passes will remain unsold. Therefore, what is needed is a mechanism that can accurately predict a value of an admission pass when it is going to be resold.

### SUMMARY

Embodiments described herein improve upon the prior art by providing systems and methods which accurately forecast a value for an admission pass to an event based on a multi-layered predictive framework which can be adapted to many regression predictive algorithms to incrementally refine the forecasted value. Each layer may predict a value for the admission pass based on different attributes of the admission pass and/or the event to which the admission pass is associated with. The example embodiments provide a mechanism that can predict a value for the admission pass based on differing attributes which are difficult to model with a single predictive algorithm, especially when market value tend to change drastically (e.g., sport team popularity, etc.) or when sample data size is not very big. The multi-layer predictive framework enables each predictive algorithm to refine or “boost” a value predicted by a previous predictive algorithm thereby improving the accuracy based on additional attributes of the admission pass and/or the event associated with the admission pass. The multi-layer predicted value for the admission pass can be provided as a valuation of the admission pass prior to the user posting the admission pass for sale via a website or other forum.

In an aspect of an example embodiment, a method may include one or more of receiving an identification of an admission pass comprising a plurality of attributes associated therewith including event attributes and seat location attributes, executing a first predictive algorithm on the event attributes which is based on event attributes of historical admission passes to generate a first predicted value for the admission pass based on values of the historical admission passes, executing a second predictive algorithm on the seat location attributes which is based on seat location attributes of the historical admission passes to generate a second predicted value for the admission pass based on the historical values of the historical admission passes, refining the first predicted value based on the second predicted value to generate a multi-layered predicted value for the admission pass.

The forecasted values on each layer can also be used to obtain information about values of the target event. For example, the values predicted by the first layer reveals information about the average game price, the 2^{nd} layer seat level values has information about how much different seat would affect the values, and so on.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating attributes that can be acquired from an admission pass in accordance with an example embodiment.

FIG. 2 is a diagram illustrating an architecture of a multi-layer predictive algorithm for predicting ticket values in accordance with an example embodiment.

FIG. 3 is a diagram illustrating an architecture of multi-layer predictive algorithm for training and prediction on new data in accordance with an example embodiment.

FIG. 4 is a diagram illustrating a method for determining a multi-layer predictive value for an admission pass in accordance with an example embodiment.

FIG. 5 is a diagram illustrating a computing system for use with any of the example embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a framework which can accurately forecast a purchase value of an admission pass to an event such as a ball game, a concert, a theatre activity, and the like. Many tickets (or other types of admission passes) are sold and resold via online forums and other markets. The prices, or the value, at which the tickets sell for can be different from a value on a face of the ticket. However, predicting an accurate fair market value can be a difficult task given the wide variety of variables that can affect the value of a ticket. In an example of professional sports game (e.g., basketball, football, soccer, baseball, hockey, etc.), the value of the ticket can be affected by event-based attributes such as the teams playing, whether the teams are likely to make the playoffs, star players, injured players, and the like. The attributes can change over time, as well. For example, event-based attributes that affect the value of a ticket one week before the event can be different than attributes that affect the value of the ticket one day before the event.

Other attributes that can contribute to fluctuation in value of a ticket include seat location variables such as section, row, seat position, whether the seat is in an isle seat or not, whether the seat is sold individually or within a group of tickets, and the like. Other attributes that can contribute to fluctuation in value include a time of day at which the event is to occur, a day of the week, a period of time between a current time and a future time/date of the event, etc. However, due to the likely big fluctuations, structures in variables, and limited data size, it is very difficult to properly consider all factors at once by popular algorithms.

The example embodiments these drawbacks by implementing a framework that breaks up the predictive model into multiple layers based on subsets of the entire data set. Each subset of data (e.g., game data, seat location data, time data, etc.) can be used to generate an independent predicted value for the ticket resulting in multiple predicted values based on the different subsets of data that are considered. The framework may aggregate the predicted values for the different subsets to generate a single multi-layered value. For example, each successive predicted value can be used to refine or otherwise boost the previously generated predicted value in an incremental fashion. Accordingly, the framework enables a user to piece together multiple predictors for a current prediction goal, each predicting on the residuals of the other. This allows a user to selectively design each step's model regarding to a specific key feature of the problem.

According to various aspects, boosting can be performed to enhance or otherwise refine the predicted value of a ticket. Boosting, in general, is an automatic process that uses weak predictors of low variance but high bias. This allows a developer to add their own knowledge, dictating how the process should go. In addition, other machine learning methods cannot subset the data as flexibly. In the examples herein, ticket price data may be subsetted in many different ways, and each subset can have its own focus for modeling. Accordingly, the would allow such flexible subsetting and prediction. In addition, each predictor can be of very different model themselves, adding another layer of flexibility.

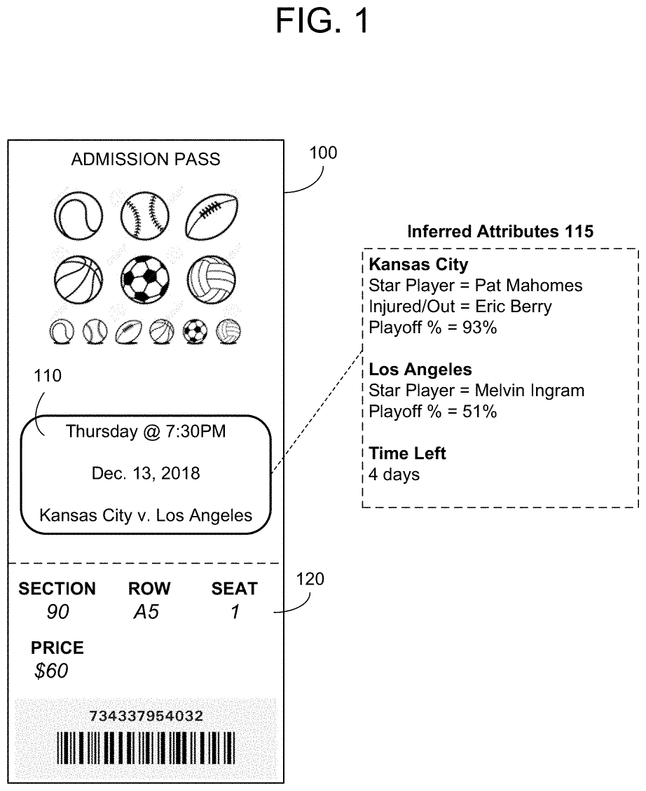

FIG. 1 illustrates attributes that can be acquired from an admission pass 100 in accordance with an example embodiment. Referring to the example of FIG. 1, the admission pass 100 includes a plurality of event attributes 110 and a plurality of seat location attributes 120. The event attributes 110 and the seat location attributes 120 may be acquired from a database, in response to an ID of the ticket being provided.

In this example, the admission pass 100 provides authorization to enter a football game (event) at a future point in time. However, it should be appreciated that the example embodiments may apply to any event, not just sports-related events. The event attributes 110 may include, but are not limited to, the teams playing, the date of the game, the time of the game, the home team, the away team, and the like. In addition to the event attributes 110 listed on the face of the admission pass 100, additional event attributes can be inferred based on underlying data associated with the event. In this example, inferred attributes 115 include star players, injured/out players, playoff percentage, and the like, of the teams that are participating in the game. Meanwhile, the seat location attributes 120 may include, but are not limited to, a section, a row, a seat number, an isle or middle seat, whether the ticket is a single/solo ticket or being sold in a group, and the like. Based on the data obtained from the admission pass 100, the framework provided herein may be used to generate a predictive model having a multi-layered structure that can accurately predict a resale value or sale value of the admission pass 100.

The embodiments provide a framework for how to achieve an accurate value using at least two layers of predictive modeling (e.g., a base layer for game information, and one or more additional layers for seat information, time information, etc.) The individual models used at each layer can vary and can be a choice of the user. The models may include any type of ML algorithm that works best. This method provides a framework, and each layer can use different predictive algorithms which include neural network, linear regression, logistic regression, Random Forest, etc. Then, the next layer can have its own predictive algorithm. There is no specific requirement on the algorithms used at each layer because they can be dynamically selected based on a user preference or model performance.

The example embodiments provide a user with a prediction of how much (e.g., a value) the user can sell a ticket for. The value of a ticket may depend on significantly different factor such as participants (teams, players, actors, etc.) seat location (good set closer to the court or bad seat far away from the court), how much time until the event, and the like. The framework executes a multi-layered predictive algorithm to forecast a ticket value based on a multiple types of attributes (e.g., game level), (seat level), and the like, and refines the game level prediction based on the seat level prediction. This is a form of selecting boosting based on a machine learning model using multiple algorithms to incorporate information from the game level (opponent, players, etc.) and seat level (seat location, corner seat, isle seat, row, etc.) Additional layers could also be added to the first two layers. For example, a third algorithm could be executed based on an amount of time until the event is to be performed. Each layer is used to adjust/refine the value in an incremental fashion.

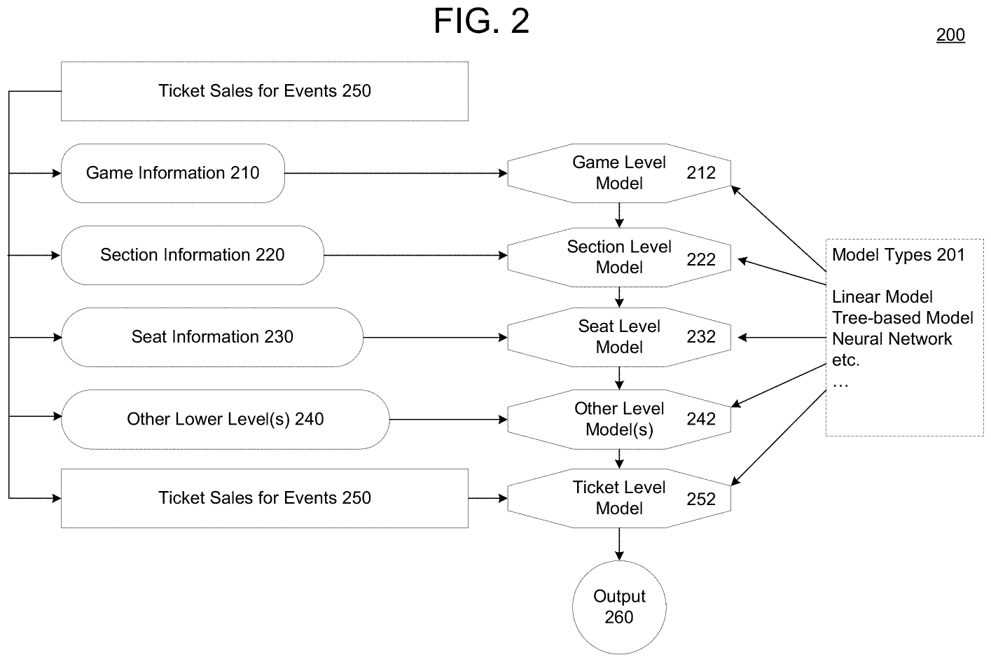

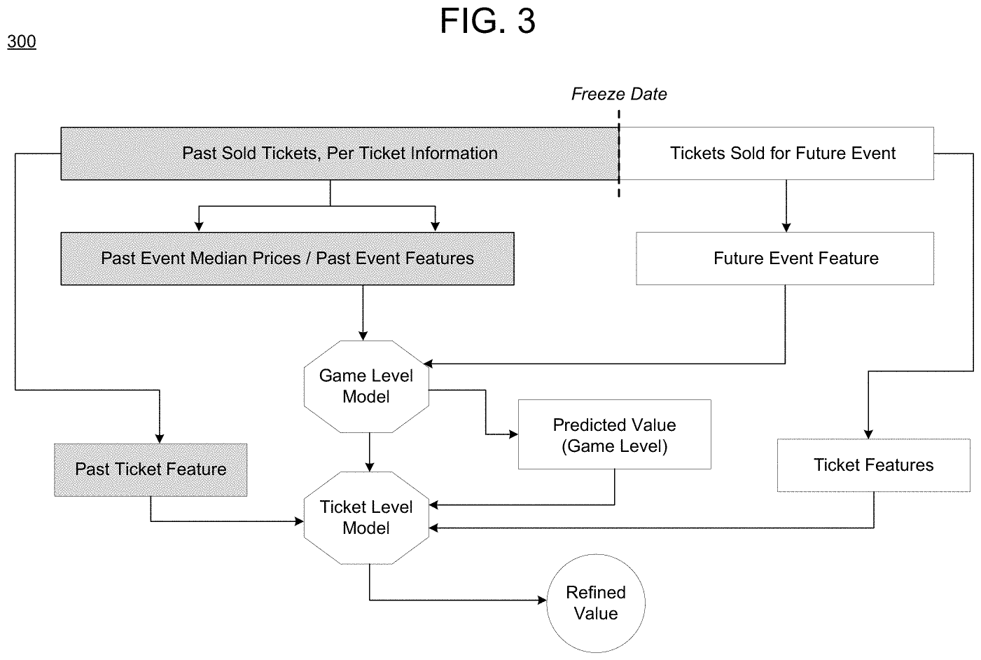

FIG. 2 illustrates an architecture 200 of a multi-layer predictive algorithm for predicting ticket values in accordance with an example embodiment, and FIG. 3 illustrates an architecture 300 of multi-layer predictive algorithm for training based on past data and prediction based on future data in accordance with an example embodiment. Referring to FIG. 2, the architecture 200 includes a plurality of layers of attributes 210, 220, 230, 240, and 250 which can be captured or otherwise identified based on ticket sales information 250 for an event. The number of layers in this example is merely for purposes of example and it should be appreciated that less layers may be included, more layers may be included, or the like. Also, different attributes may be used for the layers. The ticket sales information 250 is the largest set of information and includes information which can be used by each of the levels of the multi-layered model.

In the example of FIG. 2, a first layer of the architecture 200 is game information 210 such as information about teams playing, characters in the event, star players, time of day, day of week, holiday information, weekend information, and the like. Here, a game level model 212 is used to predict a value for a ticket price based on the game information 210. A second layer of the architecture 200 is section information 220 such as section number or letter, balcony, middle, front, back, side, floor number, etc. In this example, a section level model 222 is used to predict a value for the ticket price based on the section information 220, and is used to refine the predictive value generated based on the game level information 210 predicted by the game level model 212.

Furthermore, a third layer of the architecture 200 is seat information 230 such as seat number, row number, isle seat information, group seat information, single seat information, and the like. The seat level information 230 further narrows the section information 220 by providing a specific seat location information. Here, a seat level model 232 is used to predict a value for the ticket price based on the seat information 230. This predicted value may be used to further refine the predicted value generated by the section level model 222 and the game level model 212. Each level may incrementally refine the predicted output (value) 260 of the ticket based on different types of attributes of the ticket, event, etc. In this example, additional layer(s) 240 of information and models 242 may exist. Furthermore, a ticket level model 252 may be generated based on ticket sales for the event 250. Each level of information may be used to predict/refine the predictive value for the ticket price.

Each of the models 212, 222, 232, 242, 252, etc., may have an algorithm selected from a group include model types 201 such as linear models, tree-based models, neural networks, and the like. These algorithm types are merely for purposes of example and are not meant to limit the type of algorithm used at each level of the multi-tiered architecture 300. Furthermore, each level may have an algorithm that is designated independently from the algorithms of the other levels. In other words, each level may include different algorithm types, same algorithm types, or the like.

Referring to FIG. 3, an architecture 300 is shown which includes a dual-level architecture which takes into account game level attributes of a ticket and ticket level attributes (e.g., seat, section, etc.) of the ticket. This architecture shows data for training highlighted in grey, and future data for live predictions. Here, the training data is based on historical ticket information. At some point, a freeze date may be selected at which point past data stops being considered. The freeze data may indicate a current point in time such that all ticket information going forward in time is future ticket information. In this example, future ticket sales information may be predicted from the future ticket information after the freeze date based on the training performed using the historical ticket information previous to the freeze data to generate a multi-layered refined value for the ticket price which includes a first value predicted based on game level information and a second value (which refines the first value) and which is predicted based on ticket level information.

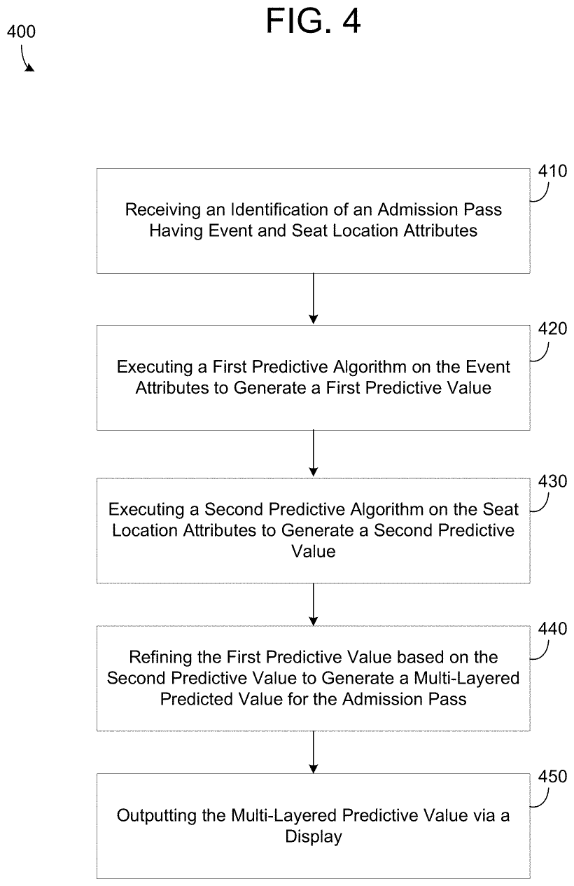

FIG. 4 illustrates a method 400 for determining a multi-layer predictive value for an admission pass in accordance with an example embodiment. For example, the method may be performed by a computing system such as a server (e.g., a web server, etc.), a user device, a cloud platform, a database, and the like. In some embodiments, the method may be performed by a single device or multiple devices. Referring to FIG. 4, in 410, the method may include receiving an identification of an admission pass comprising a plurality of attributes associated therewith including event attributes and seat location attributes. For example, the admission pass may include a ticket, a stub, a certificate, a pass, or the like, which authorizes admission to a future event such as a concert, a game (e.g., professional sports, etc.), a theatre performance, a show, a movie, or the like.

The attributes may be identified from the admission pass itself (e.g., the data of the pass stored in a database, etc.), from a scan of the admission pass, from a user input, and the like. Event attributes may include characteristics of the even such as teams and/or people participating in the event, a time of day at which the event is to occur, a venue, a date, home team versus away team, and the like. The seat location attributes may include a position in an arena, stadium, theatre, etc. where the seat is located. The seat location attributes can include a section, a row, a seat number, balcony information, standing room only, etc. In some embodiments, the seat location attributes may include whether the admission pass is being sold by itself or whether it is being sold with a bigger package of admission passes such as a group of tickets to a ball game, etc.

In some embodiments, one or more attributes may be inferred from the data identified from the admission pass, from additional data stored in a database, and the like. In some examples, the inferred attributes may include an amount of time between a current point in time and a time at which the event is scheduled to occur. As another example, the inferred attributes may be participants in the event, for example, star players, injured players not playing, actors, and the like. In some embodiments, the inferred attributes may be a likelihood that a team has of making the playoffs, and the like.

In 420, the method may include executing a first predictive algorithm on the event attributes which is based on event attributes of historical admission passes to generate a first predicted value for the admission pass based on values of the historical admission passes. Furthermore, in 430, the method may include executing a second predictive algorithm on the seat location attributes which is based on seat location attributes of the historical admission passes to generate a second predicted value for the admission pass based on the historical values of the historical admission passes. In 440, the method may include refining the first predicted value based on the second predicted value to generate a multi-layered predicted value for the admission pass, and in 450, outputting a display of the multi-layered predicted value to a display. For example, the multi-layered predicted value may be output via a user interface integrating a ticket sales website. As another example, the multi-layered predictive value may be output with a list of predicted values for a large group of tickets in the form of a document, table, spreadsheet, etc.

The first predictive algorithm and the second predictive algorithm may be dynamically selected by a user. In other words, a user may train the first and second predictive algorithms based on training data from historical admission passes (e.g., tickets, passes, etc. which have already been sold to previous events in the same venue, etc.) The first and second predictive algorithms may be selected from any known types of machine learning algorithms such as Random Forest, neural networks, regression (e.g., logistical, logical, etc.), classification, clustering, linear, and the like. The first predictive algorithm and the second predictive algorithm may be different types of machine learning algorithms or they may be the same type of machine learning algorithms. In some embodiments, further comprising receiving a selection of the first predictive algorithm and the second predictive algorithm via a common user interface.

In some embodiments, additional layers (i.e., predictive algorithms) may be added to the data flow and used to further refine the predictive value. For example, the first predicted value generated by the first predictive algorithm may be incrementally refined by the second predictive value generated by the second predictive algorithm. Each additional predictive algorithm that is executed may be used to further refine the value refined by the second predictive value. As one example, a third predictive algorithm may be based on how much time exists between a current point in time and a point in time when the event is to occur. This can be used to determine a third predictive value for the admission pass. Also, it should be appreciated that the multi-layered predictive value for the admission pass may be different than the price that is listed on the face of the admission pass.

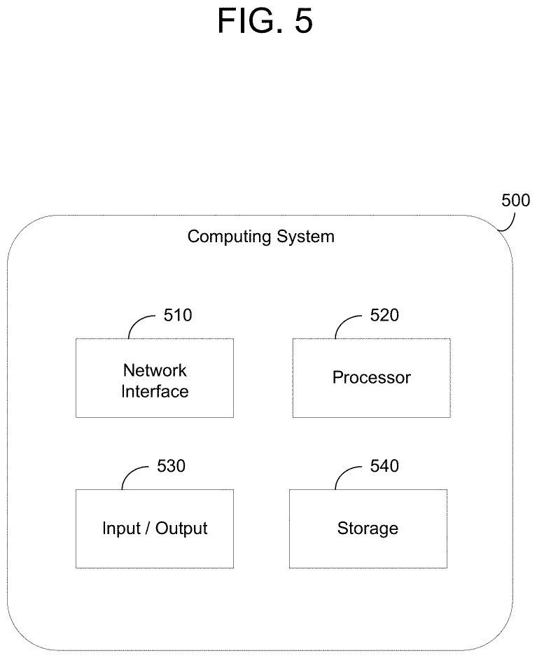

FIG. 5 illustrates a computing system 500 for determining a service contract renewal propensity in accordance with an example embodiment. For example, the computing system 500 may be a cloud platform, a server, a user device, or some other computing device with a processor. Also, the computing system 500 may perform the method of FIG. 4. Referring to FIG. 5, the computing system 500 includes a network interface 510, a processor 520, an input/output 530, and a storage device 540. Although not shown in FIG. 5, the computing system 500 may include other components such as a display, a microphone, a receiver/transmitter, and the like. In some embodiments, the processor 520 may be used to control or otherwise replace the operation of any of the components of the computing system 500.

The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. The input/output 530 may be a hardware device that includes one or more of a port, an interface, a cable, etc., that can receive data input and output data to (e.g., to an embedded display of the device 500, an externally connected display, an adjacent computing device, a cloud platform, a printer, an input unit, and the like. The storage device 540 is not limited to any particular storage device and may include any known memory device such as RAM, ROM, hard disk, and the like.

According to various embodiments, the storage 540 may store an identification of an admission pass received via a user interface. For example, the identification of the admission pass may be detected by the processor 520 based on an input received via an application executing on a user device. The identification may include a scan of a ticket bar code, a ticket number, or the like. The admission pass may be stored with a plurality of attributes associated therewith including event attributes and seat location attributes. In addition, the storage 540 may also store files, tables, documents, etc., which include additional information about the event such as team information, player/participant information, injury information, star player data, and the like.

According to various aspects, the processor 520 may execute a first predictive algorithm on the event attributes which is based on event attributes of historical admission passes to generate a first predicted value for the admission pass based on values of the historical admission passes. In addition, the processor 520 may execute a second predictive algorithm on the seat location attributes which is based on seat location attributes of the historical admission passes to generate a second predicted value for the admission pass based on the historical values of the historical admission passes. According to various embodiments, the processor 520 may incrementally refine the first predicted value based on the second predicted value to generate a multi-layered predicted value for the admission pass. Furthermore, the processor 520 may output a display of the multi-layered predicted value to a display such as an embedded display, an external display, or a network-connected display of another device (e.g., when the computing system 500 is a server, cloud platform, etc.)

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage configured to store an identification of an admission pass received via a user interface, the admission pass comprising a plurality of attributes associated therewith including event attributes and seat location attributes; and
a processor configured to
execute a first predictive algorithm on the event attributes which is based on event attributes of historical admission passes to generate a first predicted value for the admission pass based on values of the historical admission passes,
execute a second predictive algorithm on the seat location attributes which is based on seat location attributes of the historical admission passes to generate a second predicted value for the admission pass based on the historical values of the historical admission passes,
refine the first predicted value based on the second predicted value to generate a multi-layered predicted value for the admission pass, and
output a display of the multi-layered predicted value to a display.

2. The computing system of claim 1, wherein the event attributes comprise one or more of characteristics of a game and characteristics of one or more teams participating in the game.

3. The computing system of claim 1, wherein the seat location attributes comprise information about one or more of a section, a row, and a position in the row, which is assigned to the admission pass.

4. The computing system of claim 1, wherein the first predictive algorithm and the second predictive algorithm are trained using data from historical admission passes that are associated with a common location as the admission pass.

5. The computing system of claim 1, wherein the multi-layered predicted value is different than an assigned value of the admission pass.

6. The computing system of claim 1, wherein the processor is further configured to detect a selection of the first predictive algorithm and the second predictive algorithm via a common user interface.

7. The computing system of claim 1, wherein the admission pass is a certificate of admission to an event that is to occur at a future point in time.

8. The computing system of claim 1, wherein the first predictive algorithm is a different type of predictive algorithm than the second predictive algorithm.

9. A method comprising:
receiving an identification of an admission pass comprising a plurality of attributes associated therewith including event attributes and seat location attributes;
executing a first predictive algorithm on the event attributes which is based on event attributes of historical admission passes to generate a first predicted value for the admission pass based on values of the historical admission passes;
executing a second predictive algorithm on the seat location attributes which is based on seat location attributes of the historical admission passes to generate a second predicted value for the admission pass based on the historical values of the historical admission passes;
refining the first predicted value based on the second predicted value to generate a multi-layered predicted value for the admission pass; and
outputting a display of the multi-layered predicted value to a display.

10. The method of claim 9, wherein the event attributes comprise one or more of characteristics of a game and characteristics of one or more teams participating in the game.

11. The method of claim 9, wherein the seat location attributes comprise information about one or more of a section, a row, and a position in the row, which is assigned to the admission pass.

12. The method of claim 9, wherein the first predictive algorithm and the second predictive algorithm are trained using data from historical admission passes that are associated with a common venue as the admission pass.

13. The method of claim 9, wherein the multi-layered predicted value is different than an assigned value of the admission pass.

14. The method of claim 9, further comprising receiving a selection of the first predictive algorithm and the second predictive algorithm via a common user interface.

15. The method of claim 9, wherein the admission pass is a certificate of admission to an event that is to occur at a future point in time.

16. The method of claim 9, wherein the first predictive algorithm is a different type of predictive algorithm than the second predictive algorithm.

17. A non-transitory computer readable storage medium comprising instructions which when executed cause a computer to perform a method comprising:
receiving an identification of an admission pass comprising a plurality of attributes associated therewith including event attributes and seat location attributes;
executing a first predictive algorithm on the event attributes which is based on event attributes of historical admission passes to generate a first predicted value for the admission pass based on values of the historical admission passes;
executing a second predictive algorithm on the seat location attributes which is based on seat location attributes of the historical admission passes to generate a second predicted value for the admission pass based on the historical values of the historical admission passes;
refining the first predicted value based on the second predicted value to generate a multi-layered predicted value for the admission pass; and
outputting a display of the multi-layered predicted value to a display.

18. The non-transitory computer readable medium of claim 17, wherein the event attributes comprise one or more of characteristics of a game and characteristics of one or more teams participating in the game.

19. The non-transitory computer readable medium of claim 17, wherein the seat location attributes comprise information about one or more of a section, a row, and a position in the row, which is assigned to the admission pass.

20. The non-transitory computer readable medium of claim 17, wherein the multi-layered predicted value is different than an assigned value of the admission pass.
